(19) United States
(12) Patent Application Publication
(10) Pub. No.: US 2020/0368714 A1
(43) Pub. Date: Nov. 26, 2020

(54) SORBENTS COMPRISING ACTIVATED CARBON AND AMMONIUM PHOSPHATES

(71) Applicant: Cabot Corporation, Boston, MA (US)

(72) Inventors: Gerald D. Adler, Charlestown, MA (US); John M. Satterfield, Daingerfield, TX (US); Kenneth Koehlert, Hollis, NH (US)

(21) Appl. No.: 16/636,883

(22) PCT Filed: Aug. 7, 2018
(86) PCT No.: PCT/US2018/045573

§ 371 Date: Feb. 5, 2020

Related U.S. Application Data
(60) Provisional application No. 62/546,212, filed on Aug. 16, 2017.

(51) Int. Cl. B01J 20/02; B01J 20/20; B01J 20/28; B01D 53/64; B01D 53/50; B01D 53/81; B01D 53/02; F23J 15/00

(52) U.S. Cl. CPC B01J 20/0259; F23J 2215/60; B01J 20/20; B01J 20/28004; B01J 20/28016; B01D 53/64; B01D 53/508; B01D 53/81; B01D 53/02; F23J 15/003; B01D 2251/206; B01D 2251/61; B01D 2253/102; B01D 2253/25; B01D 2257/602; B01D 2257/302; B01J 20/0292

(57) ABSTRACT

Disclosed herein are particulate sorbents, such as sorbents that can be used for mercury removal applications. The absorbent can comprise at least one ammonium phosphate and at least one activated carbon selected from unhalogenated activated carbon and halogenated activated carbon, wherein the halogenated activated carbon contains at least one halogen impregnant on its surface. Also disclosed are methods of making sorbents, and methods of mercury removal, e.g., from flue gas generated by coal combustion.

### CROSS REFERENCE TO RELATED APPLICATION

This application claims priority under 35 U.S. C. § 119(e) to U.S. Provisional Patent Application No. 62/546,212 filed on Aug. 16, 2017, the disclosure of which is hereby incorporated by reference.

### FIELD OF THE INVENTION

Disclosed herein are sorbents comprising activated carbon and ammonium phosphates. Such sorbents can be used for mercury removal applications.

### BACKGROUND

Mercury is a regulated contaminant in process/discharge gases of a number of industrial operations (e.g., power plants, incinerators, and concrete kilns). Mercury may be removed from these gases by sorbents, which can be carbon or non-carbon based. The presence of impurities such as SO₃, however, can impact the effectiveness of the sorbents. Accordingly, there remains a constant need for developing sorbents for mercury removal.

### SUMMARY

One embodiment provides a particulate sorbent (e.g., a sorbent for mercury removal) comprising:

at least one ammonium phosphate; and

at least one activated carbon selected from unhalogenated activated carbon and halogenated activated carbon, wherein the halogenated activated carbon contains at least one halogen impregnant on its surface.

Another embodiment provides a method of making a particulate sorbent, comprising:

combining at least one ammonium phosphate with at least one activated carbon,

wherein the at least one activated carbon is selected from unhalogenated activated carbon and halogenated activated carbon, and wherein the halogenated activated carbon contains at least one halogen impregnant on its surface.

Another embodiment provides a method of making a particulate sorbent, comprising:

combining at least one ammonium salt with at least one raw lignite-based material to form a treated lignite-based material; and

subjecting the treated lignite-based material to a steam, gas, and/or chemical treatment at a temperature of at least 600° C. to form the particulate sorbent.

Another embodiment provides a method of mercury removal, comprising:

introducing sorbent into a flue gas generated from coal combustion (e.g., particulate sorbents disclosed herein); and

allowing the sorbent to remove mercury impurities from the flue gas.

### BRIEF DESCRIPTION OF THE DRAWING(S)

FIG. 1 is a flow chart illustrating a basic configuration of a coal-fired power plant including the pathway of the flue gas upon coal combustion;

FIG. 2 is a flow chart of a coal-fired power plant with a slipstream;

FIG. 3 is a plot of Hg removal efficiency (relative to the stack baseline) versus rate of activated carbon injection (lb/hr) of the sorbents of Example 1; and

FIG. 4 is a plot of % Hg removal versus rate of activated carbon injection (Ib/MMacf) for the sorbents of Example 2.

### DETAILED DESCRIPTION

Activated carbons are known sorbents for removing mercury impurities present in flue gases, such as flue gases generated from coal-fired industrial operations, e.g., power plants. Mercury removal or mercury adsorption is understood as removing or adsorbing elemental or ionic forms of mercury. The effectiveness of mercury removal, however, can be impacted by the presence of other impurities such as SO₃. SO₃ can compete with mercury impurities for adsorption sites on the activated carbon, effectively reducing the number of sites for mercury adsorption and consequently reducing the mercury removal efficiency. The SO₃ concentration can vary depending on the flue gas streams or conditioning of particulate removal equipment in which higher concentration of SO₃ coupled with the ability of SO₃ to competitively bind to activated carbon can present a challenge for mercury removal.

Without wishing to be bound by any theory, it has been discovered that ammonium phosphates (e.g., monoammonium phosphate, diammonium phosphate) begin to volatilize at temperatures greater than 100° C. Under such conditions, ammonium phosphates can release ammonia and can react with SO₃ to form diammonium sulfate, which forms a solid that precipitates at flue gas temperatures. Additionally, ammonium sulfates, such as diammonium sulfate, can have cohesive properties and can increase the cohesion of fly ash on precipitator plates. This increased cohesion can limit re-emission when the plates are struck when dropping accumulated material to a fly ash hopper.

Accordingly, disclosed herein are sorbents, such as particulate sorbents for mercury removal, and methods of mercury removal comprising such ammonium phosphates. Such sorbents can be effective in the presence of impurities such as SO₃. One embodiment provides a particulate sorbent for mercury removal comprising, consisting essentially of, or consisting of:

at least one ammonium phosphate; and

at least one activated carbon selected from unhalogenated activated carbon and halogenated activated carbon, wherein the halogenated activated carbon contains at least one halogen impregnant on its surface.

In one embodiment, a particulate sorbent refers to a material that can be characterized by a particle size distribution, e.g., characterized by a mean or d₅₀ particle size distribution. Particle size distributions can be determined by any method known in the art, e.g., via an LS™ 13 320 or an LS™ 200 Laser Diffraction Particle Size Analyzer, available from Beckman Coulter. In one embodiment, the particulate sorbent comprises the at least one ammonium phosphate, in particulate form, blended with the at least one activated carbon in particulate form. In another embodiment, the at least one ammonium phosphate coats a surface of the at least one activated carbon (in particulate form).

In one embodiment, the activated carbon comprises a lignite-based material. “Lignite-based” as used herein refers to a material comprising or derived primarily from a lignite. In one embodiment, a lignite-based material comprises at least 50%, at least 60%, at least 70%, at least 80%, at least 90%, at least 95%, at least 99%, or 100% lignite. The lignite can comprise a raw lignite. Raw lignite sources include those from North America, e.g., from Fort Union (North Dakota, Montana, and Saskatchewan) and the Gulf Coast (e.g., a band of near-continuous deposits from Texas to Alabama). Other sources of lignite can include deposits from Australia and Germany. Where the material comprises or is derived from 50-99% lignite, other carbonaceous sources can be mixed with the lignite. Other carbonaceous sources include any material that can be carbonized/activated upon treating with steam, gas, and/or chemical treatment at high temperature, such as in a kiln, to generate activated carbon. Exemplary carbonaceous sources that can be combined with lignite include peat, wood, lignocellulosic materials, biomass, waste, tire, olive pits, peach pits, corn hulls, rice hulls, petroleum coke, brown coal, anthracite coal, bituminous coal, sub-bituminous coal, coconut shells, pecan shells, and walnut shells, chars prepared from such materials, and other materials known in the art.

In one embodiment, the activated carbon is formed by steam activating a lignite-based material. The steam activating can comprise an initial heating step, e.g., in a kiln or a multi-hearth furnace, to remove volatile hydrocarbons, which may be accompanied by carbonization or charring. Heating can be performed at elevated temperatures of at least 600° C., at least 700° C., or at least 800° C., e.g., temperatures ranging from 600° C. to 1050° C., from 700° C. to 1050° C., from 800° C. to 1050° C., from 600° C. to 1000° C., from 700° C. to 1000° C., from 800° C. to 1000° C., from 600° C. to 900° C., from 700° C. to 900° C., from 750° C. to 900° C. or from 800° C. to 900° C. Inert gases such as nitrogen or argon may be introduced during the heating. Steam is then introduced to the kiln, optionally with compressed or process air, at the same temperatures as the initial heating step, or at temperatures ranging from 100° C. to 300° C. higher than the heating step. The residence time in the kiln (heating and/or steam activation) can vary depending on the desired properties of the activated carbon product, such as molasses RE. In one embodiment, the residence time ranges from 30 to 60 minutes, or greater than 1 h, e.g., ranging from 30 min. to 24 h, 1 h to 24 h, from 1 h to 18 h, from 1 h to 12 h, from 1 h to 6 h, from 1 h to 4 h, from 1 h to 2 h, from 2 h to 24 h, from 2 h to 18 h, from 2 h to 12 h, from 2 h to 6 h, from 2 h to 4 h, from 4 h to 24 h, from 4 h to 18 h, from 4 h to 12 h, from 4 h to 8 h, from 4 h to 6 h, or from 6 h to 24 h, from 6 h to 18 h, or from 6 h to 12 h.

In one embodiment, the at least one activated carbon is a powdered activated carbon. In one embodiment, the at least one activated carbon has a d₅₀ particle size distribution ranging from 5 μm to 30 μm, e.g., from 5 to 25 μm, from 5 to 20 μm, from 5 μm to 13 μm, from 5 μm to 12 μm, from 5 μm to 11 μm, from 5 μm to 10 μm, from 7 μm to 30 μm, from 7 μm to 25 μm, from 7 μm to 20 μm, from 7 μm to 18 μm, from 7 μm to 15 μm, from 7 μm to 13 μm, from 7 μm to 12 μm, from 7 μm to 11 μm, or from 7 μm to 10 μm.

The at least one activated carbon can be unhalogenated or halogenated. For halogenated activated carbons, the halogen can be selected from fluorine, chlorine, bromine, and iodine, which typically are present in the activated carbon as halide salts, e.g., fluoride, chloride, bromide, and iodide salts. In one embodiment, the halogen is selected from bromine. Activated carbon can be halogenated by any method known in the art, such as methods capable of depositing the halogen as an impregnant. In one embodiment, the halogen is applied onto the activated carbon by spraying a halogen solution containing at least one halogen (e.g., an aqueous solution) onto the activated carbon, e.g., by the method described in U.S. Pat. No. 8,551,431, the disclosure of which is incorporated herein by reference. In one embodiment, the solution comprises a halide salt, such as an alkali halide salt or alkaline earth metal salt e.g., NaBr, CaBr₂ salts. The halide salt can be present in a desired concentration, e.g., from 1% to 50%. In one embodiment, the spraying is performed with an atomizer spray.

In one embodiment, the presence of the halogen as an impregnant on the surface of the activated carbon can improve the distribution of the halogen (e.g., bromide) and thus the overall performance of the sorbent. In one embodiment, the presence of a halogen impregnant can be determined by scanning electron microscopy. In one embodiment, an impregnant is evidenced by a halogen (e.g., bromide) signal that is collocated with the carbon signal of the activated carbon, as determined by scanning electron microscopy. In contrast, scanning electron microscopy performed on certain commercially available sorbents show a halogen signal distinct and separate from the carbon signal, indicating that the halogen is physically mixed with the activated carbon and thus, the halogen does not exist as an impregnant on the activated carbon surface.

In one embodiment, the at least one halogen impregnant is present in an amount ranging from 1% to 8% by weight relative to the weight of the activated carbon, e.g., an amount ranging from 1% to 7%, from 1% to 6%, from 1% to 5%, from 2% to 8%, from 2% to 7%, from 2% to 6%, from 2% to 5%, from 3% to 8%, from 3% to 7%, from 3% to 6%, from 3% to 5%, from 3.5% to 8%, from 3.5% to 7%, from 3.5% to 6%, or from 3.5% to 5% by weight relative to the weight of the activated carbon. The at least one halogen impregnant can be present in the form of a salt, such as an alkali metal salt or an alkaline earth metal salt, e.g., NaBr and CaBr₂. The stated amounts of halogen impregnant refer to the weight of the halogen only do not include the weight of the metal ion.

In one embodiment, the at least one ammonium phosphate is selected from monoammonium phosphate (ammonium dihydrogen phosphate) and diammonium phosphate (DAP). In one embodiment, the at least one ammonium phosphate is present in an amount ranging from 5% to 30% by weight, relative to the weight of the activated carbon (whether unhalogenated or halogenated). In one embodiment, the at least one ammonium phosphate is present in an amount ranging from 5% to 25%, from 5% to 20%, from 5% to 15%, from 10% to 30%, from 10% to 25%, from 15% to 30% by weight, or from 15% to 25% by weight relative to the weight of the activated carbon.

In one embodiment, the particulate sorbent comprises a dry blend of the at least one activated carbon and the at least one ammonium phosphate. In one embodiment, “dry blend” as used herein refers to a physical mixture of the at least one activated carbon and the at least one ammonium phosphate. For example, the at least one ammonium phosphate (e.g., diammonium phosphate) is present in the sorbent in solid, particulate form, and has a d₅₀ particle size distribution ranging from 1 μm to 80 μm. Without wishing to be bound by any theory, it is believed that d₅₀ particle size distributions less than 80 μm allow the ammonium phosphates to volatilize under flue gas conditions and enable the removal of SO₃ impurities through the release of SO₃-reactive ammonia. In one embodiment, the at least one ammonium phosphate (e.g., diammonium phosphate) has a d₅₀ particle size distribution ranging from 10 μm to 80 μm, from 10 μm to 70 μm, from 10 μm to 60 μm, from 10 μm to 50 μm, from 15 μm to 80 μm, from 15 μm to 70 μm, from 15 μm to 60 μm, from 15 μm to 50 μm, or from 20 μm to 40 μm. In one embodiment, the at least one activated carbon in the dry blend has a d₅₀ particle size distribution ranging from 5 μm to 13 μm, from 5 μm to 12 μm, from 5 μm to 11 μm, from 5 μm to 10 μm, from 7 μm to 13 μm, from 7 μm to 12 μm, from 7 μm to 11 μm, or from 7 μm to 10 μm.

In one embodiment, the at least one ammonium phosphate (e.g., diammonium phosphate) is present in the sorbent in solid, particulate form, and has a d₅₀ particle size distribution ranging from 1 μm to 80 μm, or other ranges disclosed herein such as from 20 μm to 40 μm, and the at least one activated carbon has a d₅₀ particle size distribution ranging from 5 μm to 13 μm, or other ranges as disclosed herein.

In one embodiment, the at least one ammonium phosphate is a milled ammonium phosphate. For example, solid DAP can be obtained as a fertilizer grade diammonium phosphate (minimum 85% diammonium phosphate) and milled to a target particle size distribution, such as the d₅₀ particle size distribution ranging from 1 μm to 80 μm, or any other particle size distributions as disclosed herein. Milling can be performed by any number of devices known in the art, such as such as pulverizers, crushers, jet mills, roller mills, ball mills, hammer mills, and air classifier mills, and combinations thereof, e.g., a ball mill and air classifier.

In one embodiment, the dry blend is prepared by mixing the at least one ammonium phosphate (e.g., milled diammonium phosphate) with the at least one activated carbon by any method known in the art, e.g., with mixers (e.g., powder mixers), dispersers, drums, blenders, tumblers. As a result, the dry blend comprises a mixture of homogeneously interspersed particles of activated carbon and ammonium phosphate (e.g., diammonium phosphate). In one embodiment, the blending can be performed in conjunction with milling, e.g., with any of the milling devices disclosed herein.

In one embodiment, the at least one ammonium phosphate coats a surface of the at least one activated carbon. In one embodiment, a coating can be obtained by applying the at least one ammonium phosphate as a solution, e.g., an aqueous solution. The applying can be performed by spraying (e.g., atomizer, pneumonic spray) or by immersing the activated carbon in the solution containing the at least one ammonium phosphate (e.g., dipping). The solution can contain the at least one ammonium phosphate in any desired concentration, e.g., from 1% to 50% ammonium phosphate (e.g., diammonium phosphate), from 10% to 50%, from 20% to 50%, from 30% to 50%, from 1% to 40%, from 10% to 40%, from 20% to 40%, or from 30% to 40%, from. Upon drying, the resulting sorbent comprises the at least one activated carbon having a coating (e.g., on its surface) comprising the at least one ammonium phosphate.

In another embodiment, the at least one ammonium phosphate is intercalated with the at least one activated carbon. In one embodiment, such intercalation comprises the ammonium and phosphate groups of the at least one ammonium phosphate interspersed with the carbon network of the at least one activated carbon. In one embodiment, such intercalation can be achieved by combining the at least one ammonium phosphate with a raw lignite-based material, such as the lignites disclosed herein. As also disclosed herein, other carbonaceous sources capable of being carbonized/activated upon treating with steam, gas, and/or chemical treatment can be included with the raw lignite-based material. Subsequent carbonization/activation can result in the at least one ammonium phosphate intercalated with activated carbon.

The at least one ammonium phosphate can be combined with the raw lignite-based material as a solid or as a solution, e.g., an aqueous solution having concentrations disclosed herein (e.g., from 1% to 50% ammonium phosphate). In one embodiment, the amount of the at least one ammonium phosphate ranges from 1% to 10% by weight relative to the weight of the raw lignite-based material (e.g., lignite), e.g., from 2% to 10%, from 3% to 10%, from 2% to 9%, from 3% to 9%, from 2% to 8%, or from 3% to 8% by weight relative to the weight of the raw lignite-based material. This mixture can then be subjected to heating and activation (steam, gas and/or chemical activation) at temperatures of at least 600° C., e.g., at least 700° C., at least 800° C., or other temperatures disclosed herein for the time periods disclosed herein, e.g., from 30 min. to 24 h.

Another embodiment provides a method of making a particulate sorbent, comprising:

combining at least one ammonium phosphate with at least one activated carbon,

wherein the at least one activated carbon is selected from unhalogenated activated carbon and halogenated activated carbon, and wherein the halogenated activated carbon contains at least one halogen impregnant on its surface.

In one embodiment, the combining comprises blending the at least one ammonium phosphate with the at least one activated carbon to form a dry blend. In one embodiment, the dry blend is achieved by combining the at least one ammonium phosphate, in solid particulate form, to the at least one activated carbon. As disclosed herein, blending can be performed with mixers (e.g., powder mixers), dispersers, drums, blenders, tumblers. The blending can be performed optionally with simultaneous milling, as disclosed herein.

In one embodiment, prior to the combining, the method further comprises milling the at least one ammonium phosphate to achieve a d₅₀ particle size distribution ranging from 1 μm to 80 μm, as well as disclosed intermediate ranges up to from 20 μm to 40 μm. In one embodiment, after the milling, the combining comprises blending the at least one ammonium phosphate with the at least one activated carbon to form a dry blend. In another embodiment, the at least one ammonium phosphate is blended with the at least one activated carbon while milling, with or without prior milling of the at least one ammonium phosphate. In one embodiment, the milling comprises ball milling. In another embodiment, the milling comprises ball milling and air classifying.

In one embodiment, the combining comprises applying a solution (e.g., an aqueous solution) comprising the at least one ammonium phosphate to the at least one activated carbon. The solution can comprise the at least one ammonium phosphate having a concentration ranging from 1% to 50%, or any other ranges disclosed herein. The method can comprise applying the solution by any method known in the art, e.g., a spray, as disclosed herein (e.g., atomizer, pneumonic spray). In one embodiment, upon drying, the sorbent comprises the at least one activated carbon having a coating comprising the at least one ammonium phosphate.

Where the at least one activated carbon is selected from halogenated activated carbon, prior to the combining, the method further comprises applying a spray of a solution comprising the at least one halogen (e.g., a solution comprising a halide salt) to an activated carbon with the methods disclosed herein, e.g., a spray of droplets from an atomizer. In one embodiment, the resulting sorbent comprises a halogentaed activated carbon having a halogen impregnant on its surface.

Another embodiment provides a method of making a particulate sorbent in which the at least one ammonium phosphate is intercalated with the at least one activated carbon, as disclosed herein. In one embodiment, the method comprises:

combining at least one ammonium salt with at least one raw lignite-based material to form a treated lignite-based material; and

subjecting the treated lignite-based material to a steam, gas, and/or chemical treatment at a temperature of at least 600° C. to form the particulate sorbent.

In one embodiment, the amount of the at least one ammonium phosphate ranges from 1% to 10% by weight relative to the weight of the raw lignite-based material. The at least one ammonium phosphate can be combined as a solid (e.g., particulate form) or as a solution (e.g., an aqueous solution) having a concentration of the at least one ammonium phosphate ranging from 1% to 50%.

The subjecting comprises a steam, gas, and/or chemical treatment capable of carbonization of the raw lignite-based material at temperatures of at least 600° C., e.g., at least 700° C., or at least 800° C., or other temperatures and conditions as disclosed herein. In one embodiment, the subjecting comprises a steam treatment, i.e., steam activation.

In one embodiment, prior to the subjecting, the method further comprises heating the treated lignite-based material at a temperature of at least 600° C., e.g., at least 700° C., or at least 800° C., or other temperatures and conditions disclosed herein. The heating can be performed in the presence of an inert gas such as nitrogen or argon.

In one embodiment, the particulate sorbent comprises the at least one ammonium phosphate intercalated with an unhalogenated activated carbon. In another embodiment, the method further comprises halogenating the particulate sorbent to form a halogenated sorbent. The halogenating can be performed by applying a solution of a halide salt to the sorbent by any manner known in the art. In one embodiment, the halogenating comprises applying a spray of a solution comprising a halide salt. The spray can be a simple pneumonic spray or an atomizer, as disclosed herein.

In one embodiment, the sorbents can be used for purification applications, e.g., as a sorbent for mercury removal. Accordingly, another embodiment provides a method of mercury removal, comprising:

introducing the sorbent into a flue gas generated from coal combustion; and

allowing the sorbent to remove mercury from the flue gas.

In general, unhalogenated activated carbon adsorbs oxidized forms of mercury whereas halogenated activated carbon is more effective in removing elemental mercury as the halogen can aid in converting mercury to the more readily adsorbed oxidized form. Flue gas can contain mercury contaminants in both elemental and oxidized forms. Accordingly, one embodiment provides a sorbent comprising a blend of unhalogenated activated carbon and halogenated activated carbon containing at least one halogen impregnant on its surface.

In one embodiment, the sorbents disclosed herein provide enhanced mercury removal performance whether or not SO₃ is present. In another embodiment, the sorbents disclosed herein provide enhanced mercury removal performance in the presence of SO₃, where the flue gas has an SO₃ concentration of at least 5 ppm.

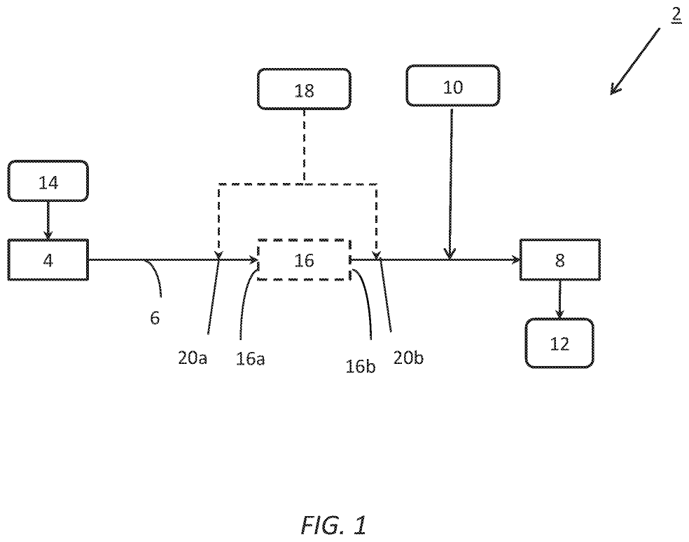

Mercury removal performance can be assessed in a system that generates a mercury-containing gas discharge. FIG. 1 is a flowchart showing the basic configuration of a power plant 2. Power plant 2 can be an operational power plant (e.g., via a slipstream), an experimental testing site, a pilot plant, or a lab scale model. Coal 14 is supplied to a boiler 4 containing water. Combustion of the coal 14 by boiler 4 heats the water to generate steam, causing flue gas to exit boiler 4 via the pathway indicated by arrow 6 through an economizer (not shown) positioned between the boiler and sorbent injection. Particulate sorbent 10 is injected downstream of boiler 4, resulting in adsorption of the mercury impurity onto sorbent 10. A particle collection device 8 separates spent sorbent 12 from the gas flow. The particle collection device 8 can comprise one or more devices known in the art, such as an electrostatic precipitator (ESP), fabric filter, or baghouse.

Optionally, power plant 2 can be configured to have an air preheater 16 positioned between boiler 4 and particle collection device 8, where air preheater 16 cools the flue gas exiting the economizer (not shown). Upstream of air preheater inlet 16a is termed the “hot side” whereas downstream of air preheater outlet 16b is termed “cold side” as temperatures can decrease by one or more hundred degrees Fahrenheit. Sorbent 10, although shown injected downstream of air heater 16, can be injected at the cold side or the hot side of air heater 16.

To determine the efficiency of mercury removal in the presence of SO₃, a source of SO₃ 18 for spiking controlled amounts into the flue gas is positioned either upstream 20a or downstream 20b of the air preheater 16.

The basic configuration of FIG. 1 can be configured in a variety of different ways. For example, the flue gas can be subjected to further treatment or purification as is known in the art.

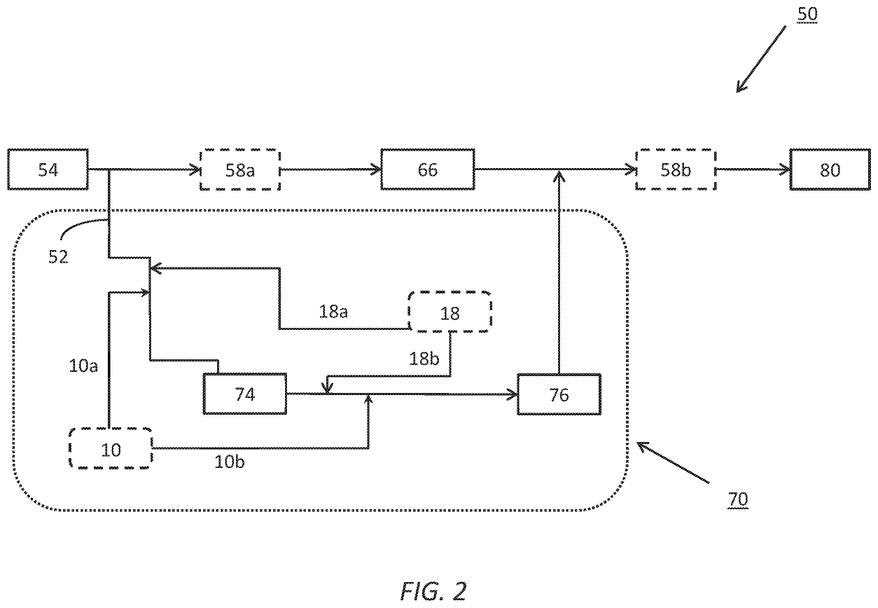

A power plant can be outfitted with a slipstream, configured for a portion of the flue gas to bypass the main path and allow testing to be performed on a smaller scale, as illustrated in FIG. 2. FIG. 2 schematically illustrates the configuration for a power plant having a slipstream. Power plant 50 of FIG. 2 comprises a boiler 54 from which flue gas is directed to an electrostatic precipitator (ESP) that can be positioned upstream (hot side ESP 58a) or downstream (cold side ESP 58b) of air preheater 66. Scrubber 80 is positioned further downstream of air heater 66 and or ESP 58b for removal of other pollutants.

In some instances, e.g., for high SO₃ flue gas streams, the significantly higher concentration of SO₃ coupled with the ability of SO₃ to competitively bind to activated carbon can present a challenge for mercury removal. For testing mercury removal in the presence of SO₃, unit 50 is outfitted with a slipstream 70 (inside dotted outline) containing bypass pathway 52 to generate flue gas having a temperature that is the average of the hot side and cold side gases. The flue gas entering slipstream 70 passes through air preheater 74, and particle collection device 76, which includes an ESP or baghouse. Sorbent 10 can be injected into inlets 10a (hot side) or 10b (cold side). Similarly, the injection of SO₃ 18 can occur on the hot side (18a) or cold side (18b). Mercury concentration can monitored before and after injection of sorbent 10 and SO₃ 18 upstream and downstream of particle collection device 76. Outlet concentration of mercury is measured with a continuous emission measuring system (e.g., Thermo Scientific™ continuous emissions monitoring system). Inlet concentration is measured using sorbent traps (EPA 30B). Sorbent traps are evaluated using an Ohio Lumex (RA-915AM Mercury Analyzer).

### EXAMPLES

### General

Particle size was determined with an LS™ 13 320 or an LS™ 200 Laser Diffraction Particle Size Analyzer.

Moisture content can be determined according to ASTM D2867, e.g., with a TGA-601 thermogravimetric analyzer from Leco Corporation.

Ash content can be determined according to ASTM D2866, e.g., with a TGA-601 thermogravimetric analyzer from Leco Corporation.

Molasses RE is determined with selected weights of a test activated carbon and selected weights of activated carbon under identical conditions to decolorize like quantities of standard blackstrap molasses solution. After decolorization of the molasses solution has reached equilibrium, color measurements are made, and the amount of color removed per unit weight of carbon is plotted (on log paper) against the amount of color remaining in the molasses solution for each sample weight of each carbon. From the plot, the color removed per unit weight of carbon when only 10% of the original color of the molasses solution remains (i.e., at 90% decolorization) is determined for each activated carbon. The relative efficiency (RE) for decolorization purposes of the test carbon is then expressed as 100 times the ratio of the color removed per unit weight by the test carbon to the color removed per unit weight by the standard carbon, at 90% decolorization.

### Example 1

This Example describes dry blending of diammonium phosphate (DAP) with an unhalogenated activated carbon sold as DARCO® Hg Extra activated carbon, available from Cabot Corporation, (“HGX”).

Fertilizer grade diammonium phosphate (minimum 85% diammonium phosphate) was milled with a ball mill (FLSmidth) connected to an air classifier (Ecutec Alpha 800), which reduces the size of the DAP from a d₅₀ of 1-2 mm (prills) to a d₅₀ target of 30±10 μm. The mill was operated under the following conditions: 3,000 lbs/hr, 1790 rpm, shot loading of 33%½″, 33% ¾″, 33% 1″ steel balls for a total of 20 tons of balls, diameter=8′, length=10′, air flow rate=10,000 CFM, fan speed=1250 rpm, and classifier speed of 375 rpm.

Blending of DAP and HGX was performed in a silo capable of containing 140,000 lbs of material. The silo was recirculated while milling at a recirculation rate of 10,000 lbs/hr. The milled DAP (35,000 lbs) was blended with 105,000 lbs of the activated carbon at a rate of 3,000 lbs/hr for 12 hours. After milling was complete, recirculation continued for an additional 24 hours. The resulting blend of the unhalogenated activated carbon (HGX) and DAP is referred to as “HGXSR.”

Mercury removal tests were conducted at Duke Energy Allen Steam Station (Unit 5), North Carolina. At Duke Energy Allen Steam Station (275 MW) mercury removal was performed on flue gas generated from Eastern Bituminous coal. The SO₃ concentration of 8-11 ppm was native to the coal (no flue gas conditioning). For air pollution control, the station is outfitted with a selective non-catalytic reduction (SNCR) system, a cold side ESP, and a wet flue-gas desulfurization (FGD) system. The activated carbon was injected downstream of the air preheater.

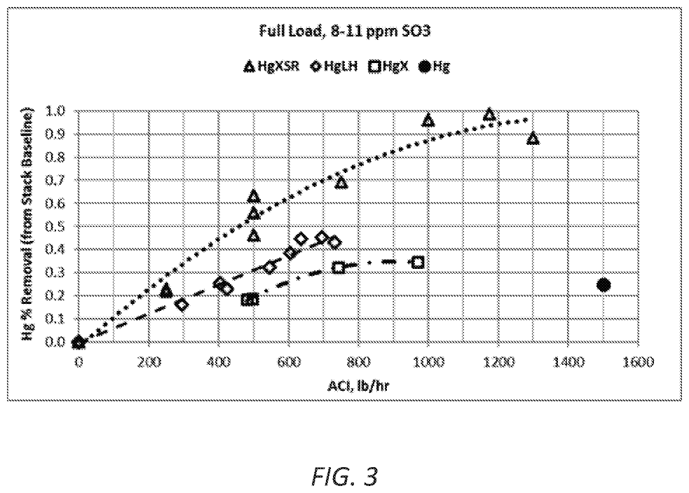

FIG. 3 shows a plot of Hg removal efficiency (relative to the stack baseline) versus rate of activated carbon injection (lb/hr), and indicates the relative superior performance of two different batches of HGXSR.

### Example 2

This Example describes dry blending of diammonium phosphate (DAP) with a brominated activated carbon sold as DARCO® Hg-LH EXTRA SP activated carbon, available from Cabot Corporation (“HGLHXSP”). HGLHXSP is the brominated form of HGX, containing 4% bromide. The blending was performed as described in Example 1. “HGLHXSR” refers to the blend of the brominated activated carbon and DAP.

Mercury removal tests were conducted at Dynegy Edwards (Unit 2), Peoria, Ill. At Dynegy Edwards, mercury removal was performed on a 270 MW of flue gas generated from Powder River Basin coal. The coal was treated with 0-20 ppm CaBr₂ for improved oxidation. The flue gas was condition with SO₃ at a concentration of 7 ppm for electrostatic precipitator (ESP) performance.

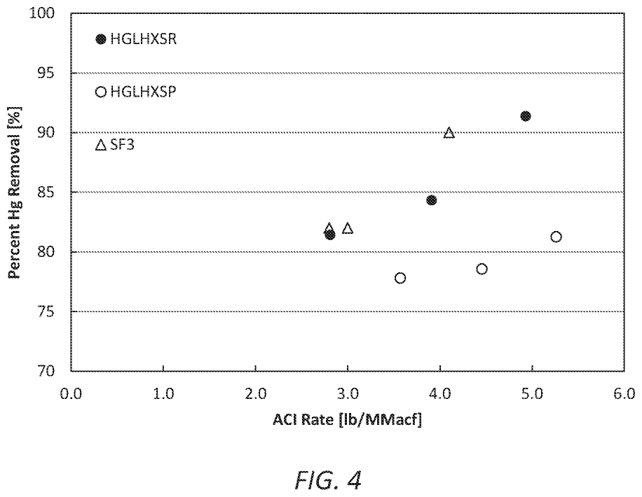

FIG. 4 shows a plot of % Hg removal versus rate of activated carbon injection (Ib/MMacf). From FIG. 4, it can be seen that HGLHXSR achieves improved performance compared to HGLHXSP in high SO₃ environment, and compared to another commercially available product, FLUEPAC® SF3, from Calgon Carbon Corporation (“SF3”).

### Example 3

This Example describes the preparation of diammonium phosphate activated carbon via pre-activation modification, i.e., modification of the raw material prior to activation.

A DAP solution (40% in water) was applied by a simple pneumatic spray to coarse raw lignite (Gulf Coast lignite). Two samples were prepared in which a first sample was prepared from 150 g DAP per 3,000 g raw lignite (“Sample A”) and a second sample was prepared from 450 g DAP per 3,000 g raw lignite (“Sample B”). The DAP-treated raw lignite samples were then loaded into a lab scale rotary activation furnace and subjected to carbonization under nitrogen at 850° C. for 45 min followed by activation under 11.58 lb/hr steam at 850° C. for 30 min. The resulting product was brominated by simple pneumatic spray of a 45% NaBr solution to achieve a bromide loading of 3.6-6.0%. The brominated product was then ball-milled to a mean particle size ranging from 17-27 μm (¼″ diameter, stainless steel media; 1425-1725 rpm mill motor speed, Model 8000 Mixer/Mill, Spex Industries). The properties of the brominated activated carbon are listed in Table 1 below.

TABLE 1

| | Treatment | Moisture, | Ash, | Molasses | Bromide, | | | |
|---|---|---|---|---|---|---|---|---|
| Sample | Method | % | % | RE | % | d5, μm | d50, μm | d95, μm |
| A | DAP Spray | 7.46 | 32.81 | 54 | 3.6 | — | 17.56 | — |
| | (150 g/3000 g) | | | | | | | |
| B | DAP Spray | 6.31 | 26.27 | 31 | 3.9 | 2.77 | 26.66 | 104.7 |
| | (450 g/3000 g) | | | | | | | |

### Example 4

This Example describes the preparation of activated carbon treated with a DAP solution (“Sample C”).

The activated carbon to be modified was a lignite furnace product (LFP) of “B” bin quality (LFPB) (particle size as obtained from activation process) that had been ball-milled to a mean particle size of approximately 18 μm (roller mill utilizing clamp sealed ceramic jars containing natural river stone ball media). A 40% w/w solution of DAP was applied by simple pneumatic spray to the activated carbon to form an activated carbon having a DAP coating in an amount of 5% by weight relative to the weight of the activated carbon. Bromination was performed as described in Example 3. The properties of Sample C are listed in Table 2 below.

TABLE 2

| | Treatment | Moisture, | Ash, | Molasses | Bromide, | | | |
|---|---|---|---|---|---|---|---|---|
| Sample | Method | % | % | RE | % | d5, μm | d50, μm | d95, μm |
| C | DAP Spray (5%) | 2.08 | 30.79 | 66 | 6.0 | 3.12 | 17.82 | 54.34 |

### Example 5

This Example describes the mercury removal performance of the DAP-modified activated carbons from Example 3.

The DAP-modified activated carbon samples were tested in a lab-scale fixed bed mercury analyzer. This test calculates mercury loading capacity onto the test material in μg Hg/g AC at equilibrium capacity. The mercury analyzer contains a glass column reactor within a combined Thermo Scientific™ Model 81i Mercury Calibrator and Thermo Scientific™ Model 80i Mercury (Hg) Analyzer. The DAP-modified activated carbon samples (2.5 mg) were blended with 5 g of sand before packing the blended samples into the fixed bed test column. Elemental mercury concentration during the test was set at 50 μg/m³ at a 1.7 L/min gas flow rate with a bed temperature of 325° F. The carrier gas (nitrogen) was either pure or spiked with a concentration of SO₃ as indicated in Table 3 below. Samples A and B of Example 3 was compared with a standard commercial product, DARCO® Hg-LH activated carbon (“HGLH”), available from Cabot Corporation.

TABLE 3

| Sample | d50, μm | SO₃ conc (ppm) | Hg Capacity (μg/g AC) |
|---|---|---|---|
| HGLH | 17.84 | 0 | 6058 |
| Sample B | 26.66 | 0 | 8505 |
| HGLH | 17.84 | 5 | 450 |
| Sample A | 17.56 | 5 | 830 |

From the Hg capacity values of Table 3, it can be seen that the DAP-modified samples outperform the commercial product at SO₃ concentrations of 0 ppm and 5 ppm.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1-33. (canceled)

34. A method of mercury removal, comprising:
introducing a particulate sorbent into a flue gas generated from coal combustion, the particulate sorbent comprising at least one ammonium phosphate, and at least one activated carbon selected from unhalogenated activated carbon and halogenated activated carbon, wherein the halogenated activated carbon contains at least one halogen impregnant on its surface; and
allowing the sorbent to remove mercury impurities from the flue gas.

35. The method of claim 34, wherein the flue gas has an SO₃ concentration of at least 5 ppm.

36. The method of claim 34, wherein the at least one activated carbon has a d₅₀ particle size distribution ranging from 5 μm to 30 μm.

37. The method of claim 34, wherein the at least one ammonium phosphate is present in an amount ranging from 5% to 30% by weight relative to the weight of the at least one activated carbon.

38. The method of claim 34, wherein the at least one ammonium phosphate comprises a milled ammonium phosphate.

39. The method of claim 34, wherein the at least one ammonium phosphate has a d₅₀ particle size distribution ranging from 1 μm to 80 μm.

40. The method of claim 34, wherein the sorbent is selected from halogenated activated carbon.

41. The method of claim 34, wherein the halogen impregnant is present in an amount ranging from 3.5% to 7% by weight relative to the weight of the at least one activated carbon.

42. The method of claim 34, wherein the sorbent is selected from unhalogenated activated carbon.

43. The method of claim 34, wherein the sorbent comprises a dry blend of the at least one ammonium phosphate and the at least one activated carbon.

44. The method of claim 34, wherein the sorbent comprises the at least one ammonium phosphate coating a surface of the at least one activated carbon.

45. The method of claim 34, wherein the at least one ammonium phosphate is selected from monoammonium phosphate and diammonium phosphate.

46. The method of claim 34, wherein the at least one ammonium phosphate comprises diammonium phosphate.
